(19) United States
(12) Patent Application Publication
(10) Pub. No.: US 2024/0041692 A1
(43) Pub. Date: Feb. 8, 2024

(54) TELESCOPIC ROTATING NEGATIVE PRESSURE MASSAGER

(71) Applicant: Dongguan Mengma Electronic Technology Co., Ltd., Dongguan City (CN)

(72) Inventor: Dongtao Zhou, Dongguan City (CN)

(21) Appl. No.: 18/244,615

(22) Filed: Sep. 11, 2023

(30) Foreign Application Priority Data
Jul. 19, 2023 (CN) 2023219167330

(51) Int. Cl. A61H 19/00

(52) U.S. Cl. CPC A61H 19/32; A61H 2201/0153; A61H 2201/1215; A61H 2201/1669

(57) ABSTRACT

The disclosure provides a telescopic rotating negative pressure massager which comprises a holding portion and a massaging portion; a telescopic rotating device driven by only one motor is provided in the holding portion, an elastic cylinder is provided in the massaging portion, the holding portion and the massaging portion are connected with each other, so that the elastic cylinder is connected with a moving member of the telescopic rotating device, a suction hole and a gas input hole are provided in a separating portion between a first housing and a second housing in a penetrating manner, a suction port of a suction pump is connected with and in communication with the suction hole through a first pipe, and an input port of a solenoid valve is connected with and in communication with the gas input hole through a second pipe. Telescopic rotating motion of the elastic cylinder can be realized by using a single motor, which lowers manufacturing cost and decrease weight and volume of the massager, and facilitate carryover, and a telescopic rotary massage function and a negative pressure massage function are realized on one massager.

### TECHNICAL FIELD

The present invention pertains to the technical field of physiotherapy devices, and specifically pertains to a telescopic rotating negative pressure massager.

### BACKGROUND

The automatic massager in the prior art, such as a telescopic rotating massager disclosed in patent publication No. CN204050242U, can provide rotary massage while performing telescopic massage. However, the telescopic rotating device of such massager needs to be equipped with two motors, resulting in a relatively heavy massager, and the two motors are arranged one after another, so that the telescopic rotating device for driving the massager to perform telescopic rotating motion have a relatively long length and a relatively large volume, thereby increasing the length and volume of the overall massager, so that it is very inconvenient to carry the massager out; therefore, an improvement is urgently needed. Furthermore, the above-mentioned massager has single massage function.

### SUMMARY

The purpose of the present invention is to provide a telescopic rotating negative pressure massager designed to solve the above-mentioned technical deficiencies.

A telescopic rotating negative pressure massager according to the present invention comprises a holding portion and a massaging portion;
the holding portion comprises a first housing, a telescopic rotating device, a suction pump and a solenoid valve, the first housing comprises a first accommodating cavity and a first connecting portion, the first connecting portion is arranged close to the massaging portion, and the telescopic rotating device, the suction pump and the solenoid valve are all located in the first accommodating cavity;
the massaging portion comprises a second housing, a connecting cylinder and an elastic cylinder, the second housing comprises a second accommodating cavity, a second connecting portion and a third opening, the third opening is arranged in communication with the second accommodating cavity, an elastic ring is mounted in the third opening, a circular shaped hole is formed on the elastic ring, the elastic ring is arranged coaxially with the elastic cylinder, so that a central axis of a massaging cavity is arranged corresponding to a central axis of the circular shaped hole, the second connecting portion is arranged close to the first connecting portion, the connecting cylinder and the elastic cylinder are both located in the second accommodating cavity, the connecting cylinder comprises a positioning cavity and a third connecting portion, the elastic cylinder is placed in and arranged in tight fit with the positioning cavity to be fixed to each other, the elastic cylinder comprises the massaging cavity and an insertion port, the insertion port is arranged in communication with the massaging cavity, a plurality of elastic protrusions are formed on an inner wall of the massaging cavity, a communicating port is provided on the connecting cylinder, and the communicating port is arranged in communication with the positioning cavity and the second accommodating cavity respectively; and
the first connecting portion and the second connecting portion are connected with each other to form a separating portion, and connect the first housing with the second housing, the separating portion separates the first accommodating chamber and the second accommodating chamber from each other, a moving member passes through the first connecting portion and the second connecting portion and is then connected with the third connecting portion, a suction hole and a gas input hole are provided on the separating portion in a penetrating manner, a suction port of the suction pump is connected with and in communication with the suction hole through a first pipe, and an input port of the solenoid valve is connected with and in communication with the gas input hole through a second pipe.

According to the telescopic rotating negative pressure massager described above, the telescopic rotating device comprises a motor, a reciprocating screw and the moving member, a positioning cylinder is fixed to an end face of the motor having a rotating shaft, the positioning cylinder comprises a positioning channel, the positioning channel is arranged along a length direction of the positioning cylinder, the rotating shaft of the motor is located at a central position in the positioning channel, the reciprocating screw is located in the positioning channel and connects a driving end of the reciprocating screw rod with the rotating shaft of the motor, an inner wall of the positioning channel is provided with a circular hole, an outer peripheral wall of the reciprocating screw rod is recessed inwards to form two spiral grooves, the two spiral grooves have opposite directions of rotation and cross each other so as to be arranged in communication with each other, an arc-shaped member is provided in the positioning channel, the arc-shaped member is placed in the spiral grooves, and an arc-shaped inner concave surface of the arc-shaped member is in contact with inner walls of the spiral grooves arranged along a length direction of the reciprocating screw; and a circular shaft is formed in the middle of an arc-shaped outer convex surface of the arc-shaped member, the circular shaft is inserted into the circular hole, and the moving member is mounted on a connecting end of the reciprocating screw.

According to the telescopic rotating negative pressure massager described above, the telescopic rotating device further comprises a guide rod, the positioning cylinder further comprises a guide end, cross sections of the positioning channel and the reciprocating screw are both arranged in a circular shape, and a circumferential outer wall of the reciprocating screw is adhered to and in clearance fit with a circumferential inner wall of the positioning channel; the guide rod is arranged along the length direction of the positioning cylinder, and the guide rod is fixed to the moving member; and the guide end is provided with a guide through hole, and the guide rod runs through the guide through hole.

According to the telescopic rotating negative pressure massager described above, the positioning cylinder comprises a first sleeve body, a second sleeve body and a guide plate, the positioning channel is formed at a central position of the second sleeve body, the first sleeve body is socketed onto the second sleeve body in order to be fixed to each other, an end face of the second sleeve body facing the moving member is provided with a mounting table, one side of the guide plate facing the motor and the mounting table are provided with a recess with a semi-circular cross section, and the recess is arranged to extend radially; after the guide plate is fixed to the end face of the second sleeve facing the moving member, the two recesses are symmetrically assembled with each other to form a circular hole; and a guide hole is provided on the guide plate.

According to the telescopic rotating negative pressure massager described above, a connecting member is connected to the moving member, the connecting member comprises a connecting plate, and a first positioning body and a second positioning body arranged around the connecting plate, the first positioning body and the second positioning body are connected to the connecting plate, and the first positioning body and the second positioning body are arranged at intervals.

According to the telescopic rotating negative pressure massager described above, the third connecting portion comprises a connecting ring body, the connecting ring body is sleeved on the connecting member; an outer wall of the first positioning body and an inner wall of the connecting ring body are respectively provided with a snap and a snap-in groove; an outer wall of the second positioning body and the inner wall of the connecting ring body are respectively provided with a positioning groove and a positioning block; and the snap is snap-connected in the snap-in groove; and the positioning block is embedded into the positioning groove.

According to the telescopic rotating negative pressure massager described above, the first connecting portion is a connecting sleeve, the first housing further comprises a first opening, the first opening is in communication with the first accommodating cavity, the connecting sleeve is threaded into the first opening, and an outer wall of the connecting sleeve is snap-connected with an inner wall of the first opening; and a mounting channel is provided on the connecting sleeve, the mounting channel is arranged in a penetrating manner along a length direction of the first housing, and the telescopic rotating device is mounted in the mounting channel.

According to the telescopic rotating negative pressure massager described above, the second connecting portion is a second opening, the second opening is in communication with the second accommodating cavity, the connecting sleeve is further threaded into the second opening, and the outer wall of the connecting sleeve and an inner wall of the second opening are snap-connected to each other.

The telescopic rotating negative pressure massager according to the present invention has the following beneficial effects: 1. Telescopic rotating motion of the elastic cylinder can be realized by using a single motor, which lowers manufacturing cost and decrease weight and volume of the massager, and facilitate carryover, and a telescopic rotary massage function and a negative pressure massage function are practiced on one massager. 2. The assembly and disassembly are facilitated by the snap-in detachable connection between the elastic cylinder and the telescopic drive bracket.

### BRIEF DESCRIPTION OF THE DRAWINGS

FIG. 1 is an exploded view of an overall structure;

FIG. 2 is an overall cross-sectional view;

FIG. 3 is an enlarged view of A;

FIG. 4 is a structural schematic view of a holding portion;

FIG. 5 is a structural schematic view of combining a connecting cylinder and an elastic cylinder;

FIG. 6 is a structural schematic view of combining a telescopic rotating device and a connecting sleeve;

FIG. 7 is a structural schematic view of a second housing;

FIG. 8 is a structural schematic view of a telescopic rotating device (I);

FIG. 9 is a structural schematic view of a positioning cylinder;

FIG. 10 is a structural schematic view of the telescopic rotating device (II);

FIG. 11 is a structural schematic view of a reciprocating screw; and

FIG. 12 is a structural schematic view of an arc-shaped member.

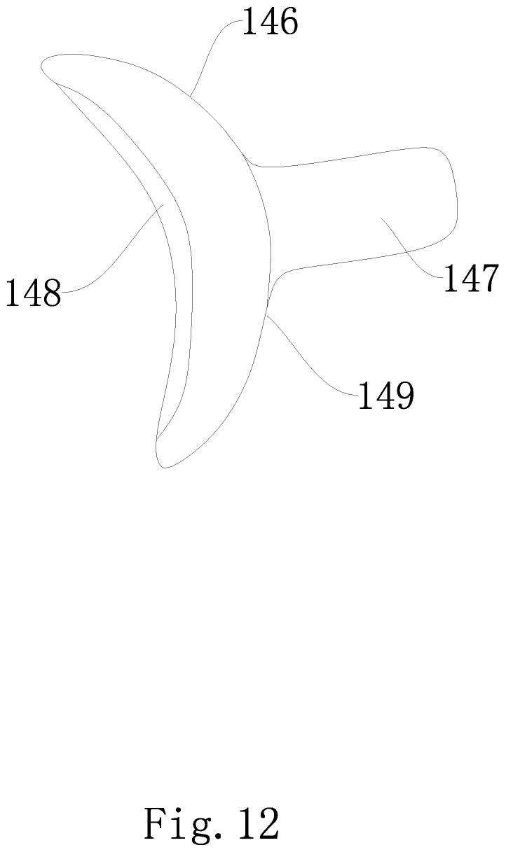

In the figures: 1. holding portion; 11. first housing; 111. first accommodating cavity; 112. first opening; 113. clamping block; 13, telescopic rotating device; 131. moving member; 132. reciprocating screw; 133. motor; 134. positioning cylinder; 135. guide end; 136. guide plate; 137. positioning channel; 138. guide hole; 139. guide rod; 14. suction pump; 141. first sleeve body; 142. second sleeve body; 143. fixing plate; 144. mounting sleeve; 145. recess; 146. arc-shaped member; 147. circular shaft; 148, arc-shaped inner concave surface; 149, arc-shaped outer convex surface; 15. solenoid valve; 151, spiral groove; 16, connecting sleeve; 161. mounting channel; 162. clamping groove; 163. limiting block; 17. fixing bracket; 18. controller; 181. control key; 19. connecting member; 191. connecting plate; 192. first positioning body; 193. second positioning body; 194. snap; 195. positioning groove; 2. massaging portion; 21. second housing; 211. second accommodating cavity; 212. second opening; 213. third opening; 214. annular clamping block; 215. limiting groove; 22. connecting cylinder; 221. connecting ring body; 222. positioning cavity; 223. snap-in groove; 224. positioning block; 23. elastic cylinder; 231. massaging cavity; 232, elastic protrusion; 3, massaging ring; 31. circular-shaped hole; 32. annular clamping groove; 4. end cover; and 5. battery.

### DESCRIPTION OF THE EMBODIMENTS

The technical solutions of the embodiments of the present invention will be described clearly and completely below with reference to the accompanying drawings in the embodiments of the present invention, and it is obvious that the embodiments described are only some, instead of all, of the embodiments of the present invention. All other embodiments obtained by those of ordinary skill in the art based on the embodiments of the present invention fall within the scope of the present invention.

### EMBODIMENTS

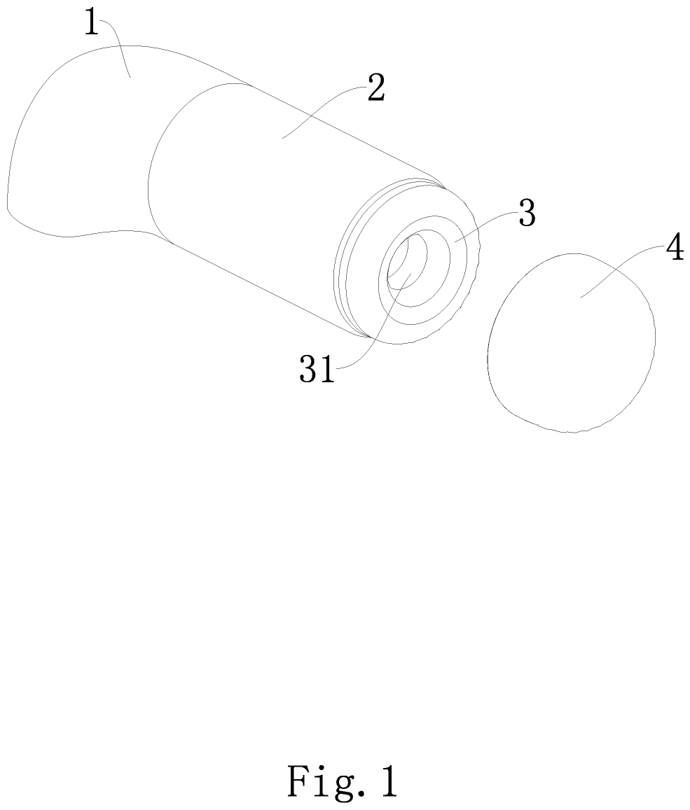

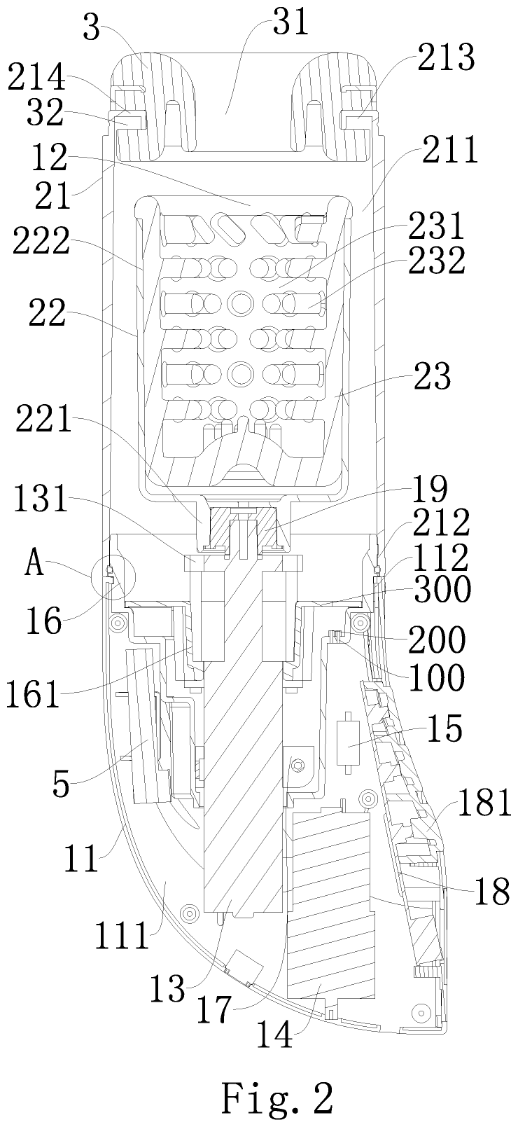

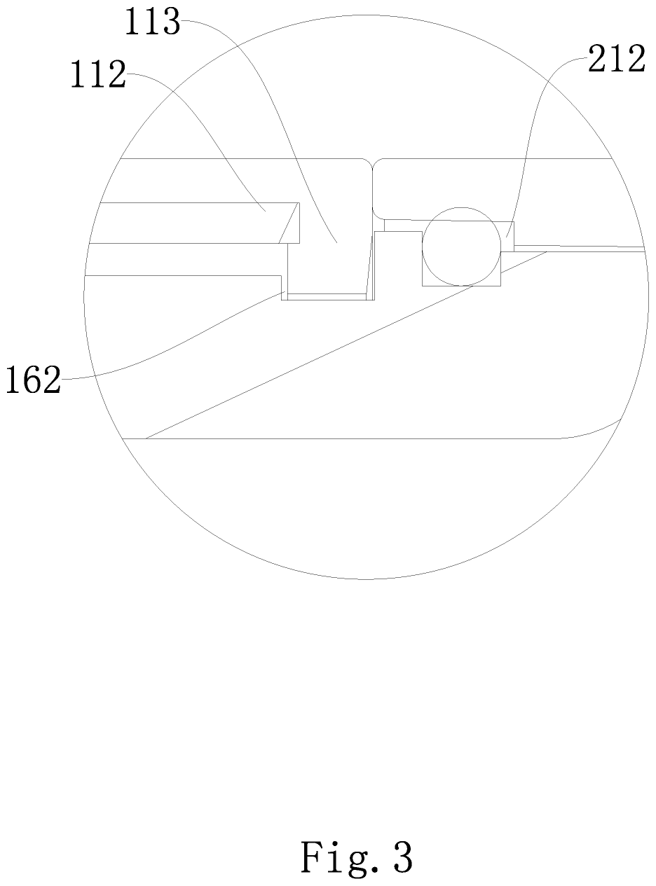

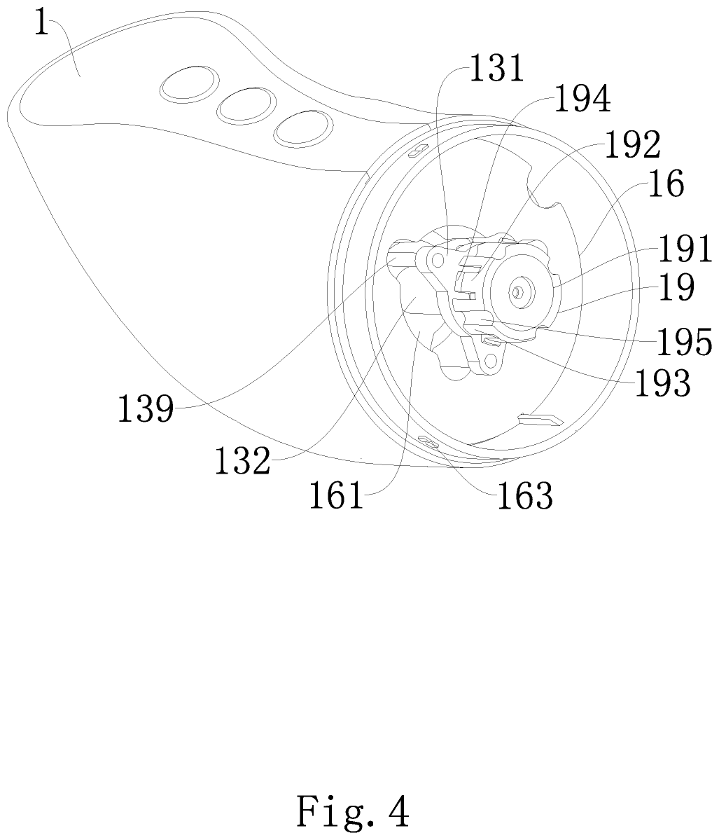

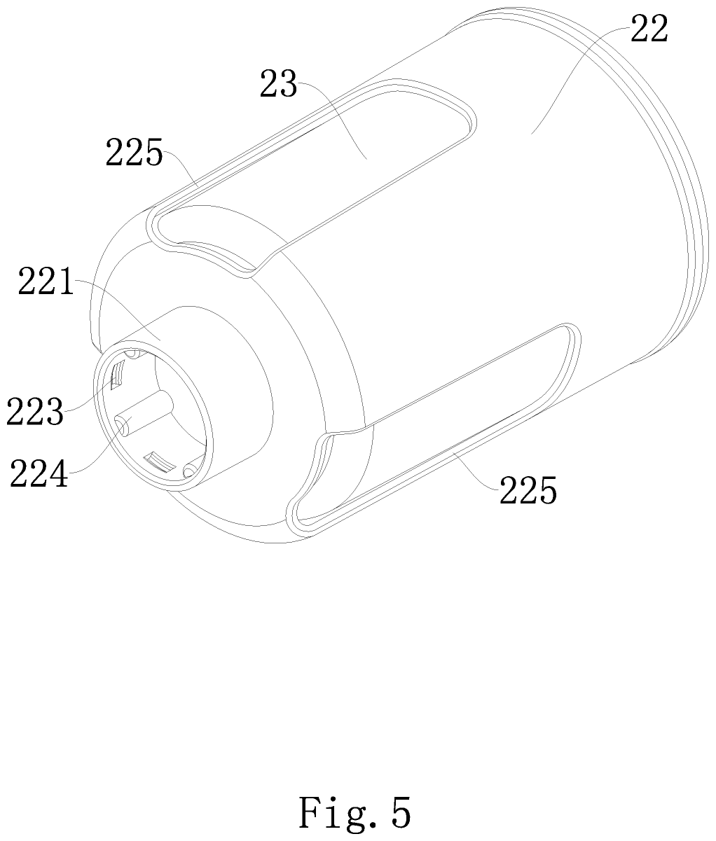

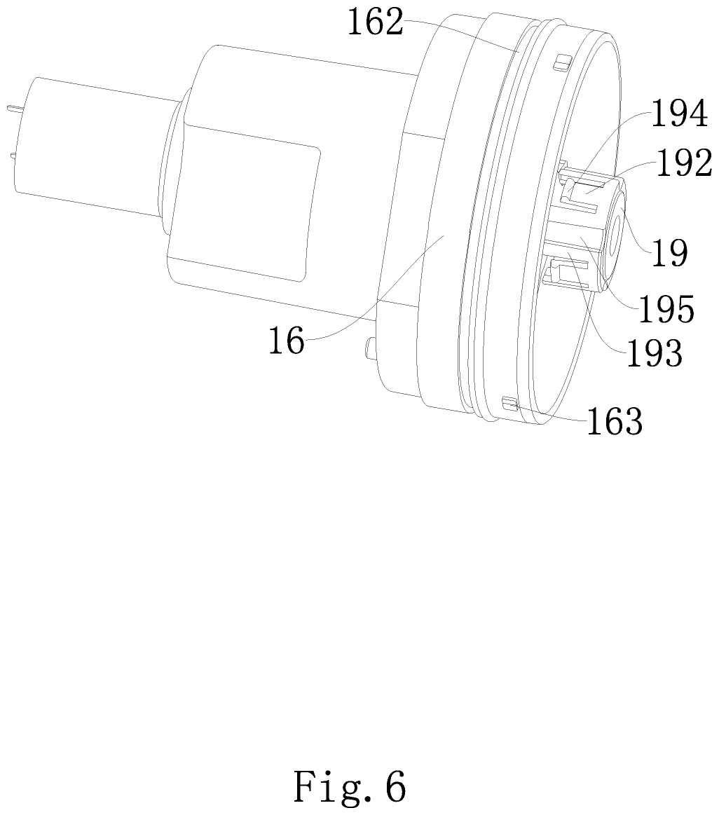

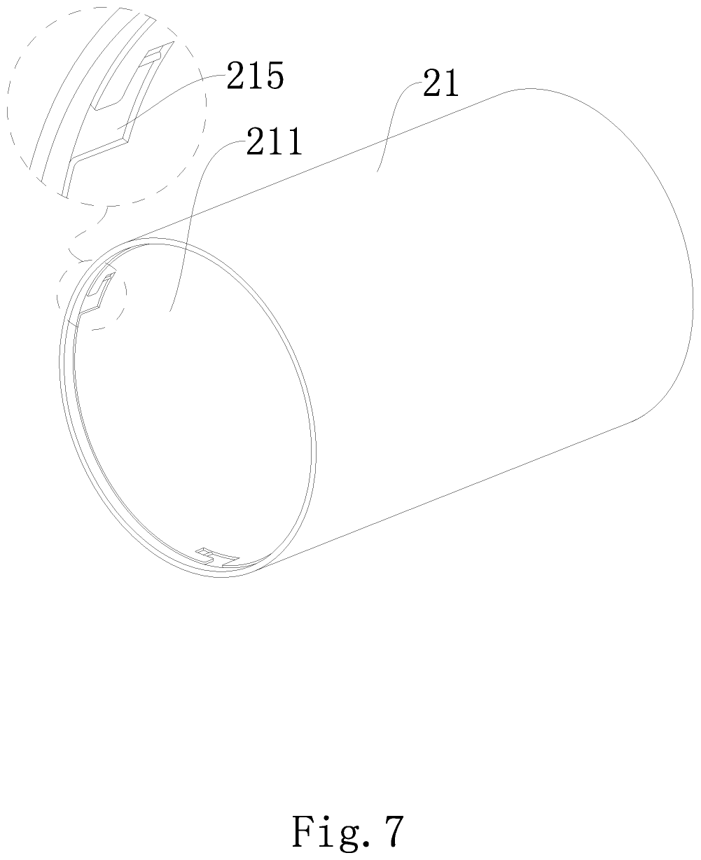

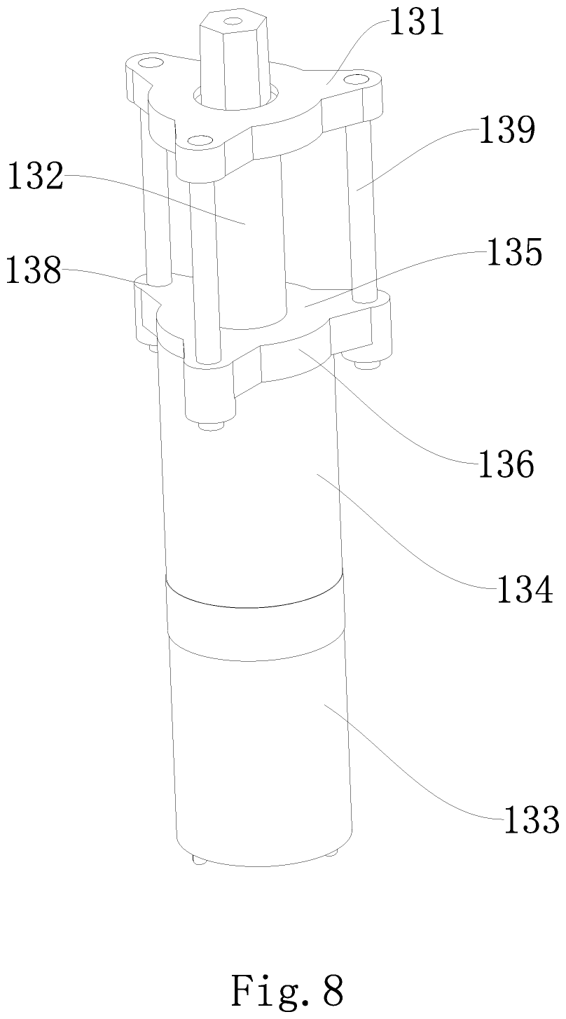

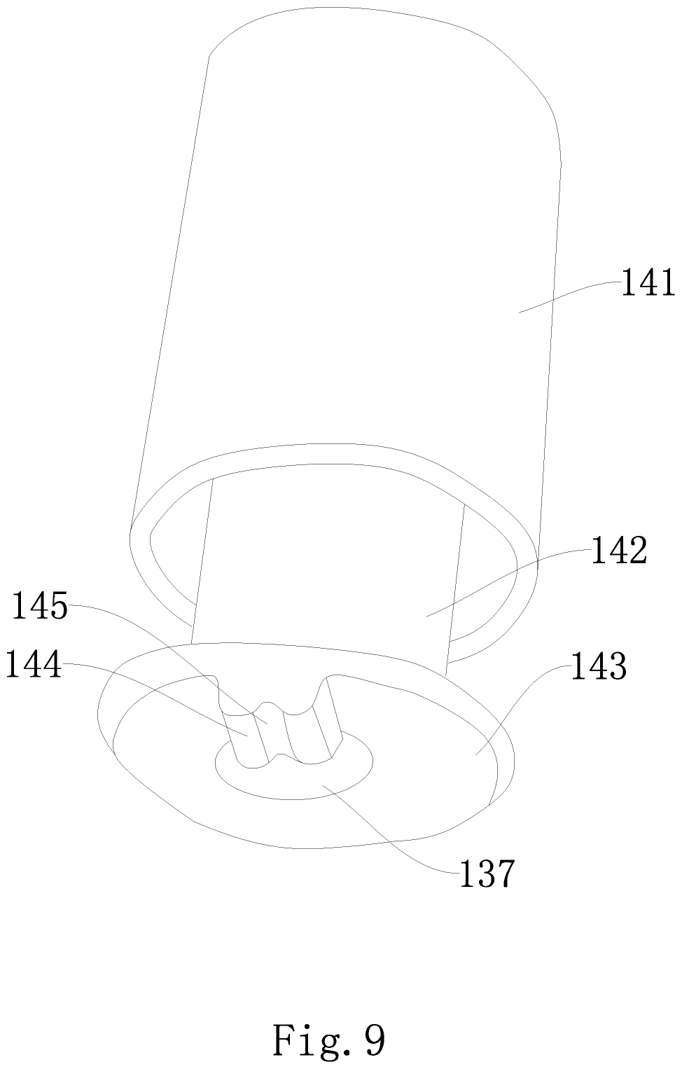

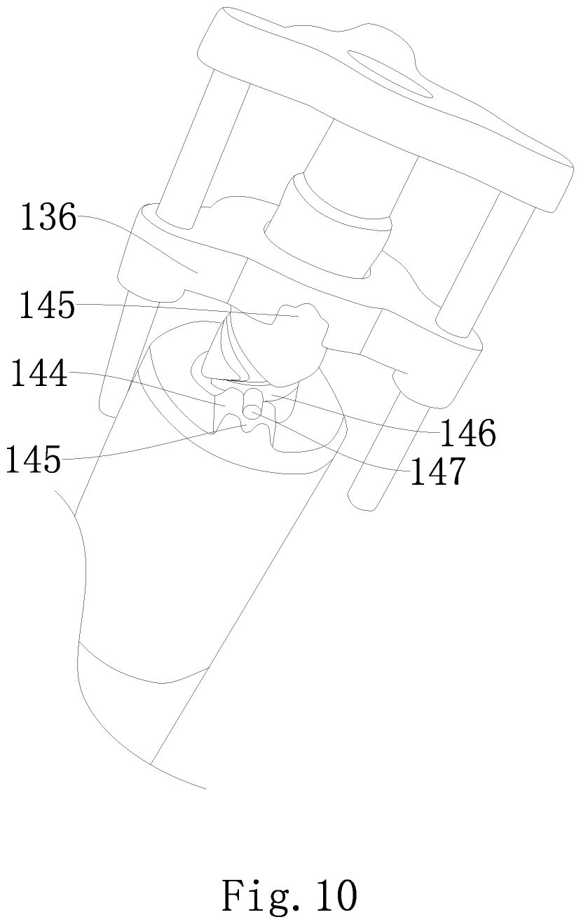

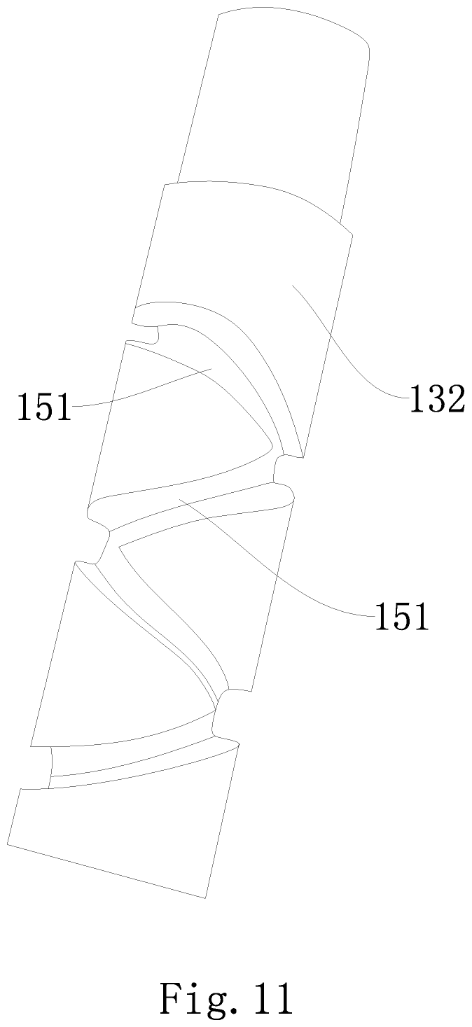

As shown in FIGS. 1 to 11, a telescopic rotating negative pressure massager described in the present embodiment is configured to massage a user's body, especially sensitive portions of the body, or may be manufactured to fit the size of fingers for finger massage.

The telescopic rotating negative pressure massager comprises a holding portion 1 and a massaging portion 2; the holding portion 1 is arranged in a curved manner so as to be convenient to hold, and the massaging portion 2 is arranged in a straight manner so as to be convenient to massage.

The holding portion 1 comprises a first housing 11, a telescopic rotating device 13, a suction pump 14 and a solenoid valve 15; the first housing 11 comprises a first accommodating cavity 111 and a first connecting portion; the first housing 11 is composed of two half shells made of a plastic material, and the half shells are symmetrically assembled and fixed to each other to form the first accommodating cavity 111; the first connecting portion is arranged close to the massaging portion 2; the telescopic rotating device 13, the suction pump and the solenoid valve 15 are all located in the first accommodating cavity 111; the first connecting portion is a connecting sleeve 16, and the connecting sleeve 16 is arranged in a circular shape; the first housing 11 further comprises a first opening 112, the first opening 112 is in communication with the first accommodating cavity 111, the connecting sleeve 16 is threaded into the first opening 112, and an outer wall of the connecting sleeve 16 is in snap-in connection with an inner wall of the first opening 112, that is, the outer wall of the connecting sleeve 16 forms a clamping groove 162; the inner wall of the first opening 112 forms a clamping block 113, and the clamping block 113 is correspondingly embedded in the clamping groove 162; and a mounting channel 161 is provided on the connecting sleeve 16, the mounting channel 161 is arranged in a penetrating manner along a length direction of the first housing 11, and the telescopic rotating device 13 is mounted in the mounting channel 161.

The telescopic rotating device 13 comprises a motor 133, a reciprocating screw 132 and a moving member 131; a positioning cylinder 134 is fixed to an end face of the motor 133 having a rotating shaft, the positioning cylinder 134 comprises a positioning channel 137, the positioning channel 137 is arranged along a length direction of the positioning cylinder 134, the rotating shaft of the motor 133 is located at a central position in the positioning channel 137, the reciprocating screw 132 is located in the positioning channel 137 and connects a driving end of the reciprocating screw 132 with the rotating shaft of the motor 133, cross sections of the positioning channel 137 and the reciprocating screw 132 are both arranged in a circular shape, and a circumferential outer wall of the reciprocating screw 132 is adhered to and in clearance fit with a circumferential inner wall of the positioning channel 137; an inner wall of the positioning channel 137 is provided with a circular hole, an outer peripheral wall of the reciprocating screw 132 is recessed inwardly to form two spiral grooves 151, the two spiral grooves 151 have opposite directions of rotation and cross each other so as to be arranged in communication with each other, that is, middle portions of the two spiral grooves 151 are in cross communication with each other and two ends thereof are in communication with each other, an arc-shaped member 146 is provided in the positioning channel 137, the arc-shaped member 146 is placed in the spiral grooves 151, and an arc-shaped inner concave surface 148 of the arc-shaped member 146 is in contact with inner walls of the spiral grooves 151 arranged along a length direction of the reciprocating screw 132; a circular shaft 147 is formed in the middle of an arc-shaped outer convex surface 149 of the arc-shaped member 146, the circular shaft is inserted into the circular hole, and the moving member 131 is mounted on a connecting end of the reciprocating screw 132; the positioning cylinder 134 is sheathed with a fixing bracket 17, and the fixing bracket 17 is fixed on an inner wall of the mounting channel 161 by a bolt; and rotation of the rotating shaft of the motor 133 drives rotation of the reciprocating screw 132, and at this point, the reciprocating screw 132 is caused to rotate and move telescopically under the guidance of the arc-shaped member 146 and the spiral grooves 151 to drive the moving member 131 to move telescopically.

The massaging portion 2 comprises a second housing 21, a connecting cylinder 22 and an elastic cylinder 23, the connecting cylinder 22 and the elastic cylinder 23 are both circular cylinder structures, the second housing 21 comprises a second accommodating cavity 211 and a second connecting portion, the second connecting portion is arranged close to the first connecting portion, the connecting cylinder 22 and the elastic cylinder 23 are both located in the second accommodating cavity 211, the connecting cylinder 22 comprises a positioning cavity 222 and a third connecting portion, the elastic cylinder 23 is placed in and arranged in tight fit with the positioning cavity 222 to be fixed to each other; the elastic cylinder 23 comprises a massaging cavity 231, a communicating port and an insertion port, the communicating port and the insertion port are both arranged in communication with the massaging cavity 231, and a plurality of elastic protrusions 232 are formed on an inner wall of the massaging cavity 231; the elastic cylinder 23 and the elastic protrusions 232 are combined with each other into an integral structure and made of a silica gel material; and an inner diameter of the massaging cavity 231 matches an outer diameter of an area to be massaged, so that the elastic protrusions 232 can abut against the area to be massaged under an elastic action.

The second housing 21 further comprises a second opening 212 and a third opening 213, and the second opening 212 and the third opening 213 are respectively in communication with the second accommodating cavity 211; the outer wall of the connecting sleeve 16 and an inner wall of the second opening 212 are respectively provided with a limiting block 163 and an L-shaped limiting groove 215; an inner wall of a transverse groove of the limiting groove 215 is provided with a limiting projection, after the connecting sleeve 16 is threaded into the second opening 212, the limiting block 163 enters the transverse groove thereof through a longitudinal groove of the limiting groove 215, and then the connecting sleeve 16 rotates relative to the second housing 21, causing the limiting block 163 to go over the limiting protrusion so that the limiting protrusion is limited in the transverse groove; the connecting sleeve 16 and the limiting block 163 constitute the first connecting portion, the second opening 212 and the limiting groove 215 constitute the second connecting portion, therefore, the first connecting portion and the second connecting portion are connected with each other to form a separating portion, and connect the first housing 11 with the second housing 21; and the separating portion also separates the first accommodating cavity and the second accommodating cavity from each other, a communicating port 225 is provided on the connecting cylinder 22, and the communicating port 225 is arranged in communication with the positioning cavity and the second accommodating cavity 211 respectively.

Preferably, an elastic ring is mounted in the third opening 213, that is, an annular-shaped clamping groove 32 recessed inwards is formed on an outer peripheral surface of the elastic ring, an annular clamping block 214 protruding radially is formed on an inner wall of the third opening 213, the annular clamping block 214 is correspondingly embedded in the annular clamping groove 32, a circular shaped hole 31 is formed on the elastic ring, and the elastic ring is arranged coaxially with the elastic cylinder 23, so that a central axis of the massaging cavity 231 corresponds to a central axis of the circular shaped hole 31; and the elastic ring is also made of a silica gel material, so that the area to be massaged at the position of the third opening 213 of the second housing 21 is relatively comfortable, and the third opening 213 is also covered with an end cover 4.

The moving member 131 passes through the connecting sleeve 16, the first opening 112 and the second opening 212 and is then connected with the third connecting portion, that is, a connecting member 19 is connected to the moving member 131; the connecting member 19 comprises a connecting plate 191, and a first positioning body 192 and a second positioning body 193 arranged around the connecting plate 191, the first positioning body 192 and the second positioning body 193 are connected to the connecting plate 191, the connecting plate 191 is fixed to the moving member 131 by a bolt, and the first positioning body 192 and the second positioning body 193 are arranged at intervals; the third connecting portion comprises a connecting ring body 221, and the connecting ring body 221 is sleeved on the connecting member 19; an outer wall of the first positioning body 192 and an inner wall of the connecting ring body 221 are respectively provided with a snap 194 and a snap-in groove 223, and an outer wall of the second positioning body 193 and the inner wall of the connecting ring body 221 are respectively provided with a positioning groove 195 and a positioning block 224; the snap 194 is snap-connected in the snap-in groove 223, and the positioning block 224 is embedded into the positioning groove 195; wherein the snap 194 and the positioning block 224 may be arranged on the outer wall of the first positioning body 192, and the snap-in groove 223 and the positioning groove 195 may be arranged on the inner wall of the connecting ring body 221; alternatively, the snap 194 and the positioning block 224 may be arranged on the inner wall of the connecting ring body 221, and the snap-in groove 223 and the positioning groove 195 may be arranged on the outer wall of the first positioning body 192.

During telescopic rotating massage, the elastic cylinder 23 is driven to perform telescopic rotating motion, so that the elastic protrusions 232 perform friction massage on the area to be massaged.

A suction hole and a gas input hole are provided on the separating portion in a penetrating manner, a suction port of the suction pump 14 is connected with and in communication with the suction hole through a first pipe, and an input port of the solenoid valve 15 is connected with and in communication with the gas input hole through a second pipe; a cover plate is mounted at an port of the connecting sleeve 16, the cover plate is arranged such that the first accommodating cavity and the second accommodating cavity are further reliably separated; and a through hole is provided on the cover plate 300, and the through hole is arranged in communication with the second accommodating cavity, the suction hole and the gas input hole.

During negative pressure massage, after the area to be massaged is placed into the massaging cavity of an elastic cylinder through the circular shaped hole, an inner wall of the circular shaped hole of the elastic ring is closely adhered to the area to be massaged, and fits with the connecting sleeve and the second accommodating cavity to form a closed space; at this point, the solenoid valve (15) is in an off state, the suction pump 14 is started to suck air into the closed space, so that a negative pressure is generated in the closed space, and the negative pressure is applied to the elastic cylinder, so that the elastic cylinder tightly binds the area to be massaged to achieve negative pressure massage; and after a period of massage, the solenoid valve 15 is controlled to be on to allow air to enter the closed space through the solenoid valve, so as to cause the negative pressure to disappear, and allow a user to manipulate the massager in the above-mentioned negative pressure massage manner to perform multiple negative pressure massages during massage.

A controller 18 and a battery 5 are fixed to an inner wall of the second accommodating cavity 211, the battery 5 is connected with the motor 133, the solenoid valve 15 and the suction pump 14 through the controller 18, a control key 181 is provided on the controller 18, and a program for controlling operation of the motor 133, the solenoid valve 15 and the suction pump 14 is built in the controller 18 so as to achieve the telescopic rotating massage or the negative pressure massage.

In the present embodiment, the telescopic rotating device 13 further comprises a guide rod 139, the positioning cylinder 134 further comprises a guide end 135, the guide rod 139 is arranged along the length direction of the positioning cylinder 134, and the guide rod 139 is fixed to the moving member 131; and the guide end 135 is provided with a guide through hole, and the guide rod 139 runs through the guide through hole, so that the reciprocating screw 132 moves more stably and reliably.

Preferably, the positioning cylinder 134 comprises a first sleeve body 141, a second sleeve body 142 and a guide plate 136, the positioning channel 137 is formed at a central position of the second sleeve body 142, the first sleeve body 141 is socketed onto the second sleeve body 142 in order to be fixed to each other, a fixing plate 143 is formed on a peripheral side of one end of the second sleeve body 142 facing the moving member 131, the fixing plate 143 is formed by radial extension, and the fixing plate 143 is fixedly connected with an end face of the first sleeve body 141 facing the moving member 131 by a bolt; an end face of the second sleeve body 142 facing the moving member 131 is provided with a mounting table, one side of the guide plate 136 facing the motor 133 and the mounting table are provided with a recess 145 with a semi-circular cross section, and the recess 145 is arranged to extend radially; after the guide plate 136 is fixed to the end face of the second sleeve 142 facing the moving member 131 by a bolt, the two recesses 145 are symmetrically assembled with each other to form a circular hole; and a guide hole 138 is provided on the guide plate 136, which facilitates assembly.

The present invention is not limited to the above-mentioned preferred embodiments, and any other products in various forms can be obtained by anyone in the light of the present invention, but any changes in the shape or structure thereof, which have the same or similar technical solutions as those of the present application, fall within the scope of the present invention.

What is claimed is:

1. A telescopic rotating negative pressure massager, comprising a holding portion and a massaging portion; wherein
the holding portion comprises a first housing, a telescopic rotating device, a suction pump and a solenoid valve, the first housing comprises a first accommodating cavity and a first connecting portion, the first connecting portion is arranged close to the massaging portion, and the telescopic rotating device, the suction pump and the solenoid valve are all located in the first accommodating cavity;
the massaging portion comprises a second housing, a connecting cylinder and an elastic cylinder, the second housing comprises a second accommodating cavity, a second connecting portion and a third opening, the third opening is arranged in communication with the second accommodating cavity, an elastic ring is mounted in the third opening, a circular shaped hole is formed on the elastic ring, the elastic ring is arranged coaxially with the elastic cylinder, so that a central axis of a massaging cavity is arranged corresponding to a central axis of the circular shaped hole, the second connecting portion is arranged close to the first connecting portion, the connecting cylinder and the elastic cylinder are both located in the second accommodating cavity, the connecting cylinder comprises a positioning cavity and a third connecting portion, the elastic cylinder is placed in and arranged in tight fit with the positioning cavity to be fixed to each other, the elastic cylinder comprises the massaging cavity and an insertion port, the insertion port is arranged in communication with the massaging cavity, a plurality of elastic protrusions are formed on an inner wall of the massaging cavity, a communicating port is provided on the connecting cylinder, and the communicating port is arranged in communication with the positioning cavity and the second accommodating cavity respectively; and
the first connecting portion and the second connecting portion are connected with each other to form a separating portion, and connect the first housing with the second housing, the separating portion separates the first accommodating chamber and the second accommodating chamber from each other, a moving member passes through the first connecting portion and the second connecting portion and is then connected with the third connecting portion, a suction hole and a gas input hole are provided on the separating portion in a penetrating manner, a suction port of the suction pump is connected with and in communication with the suction hole through a first pipe, and an input port of the solenoid valve is connected with and in communication with the gas input hole through a second pipe.

2. The telescopic rotating negative pressure massager according to claim 1, wherein the telescopic rotating device comprises a motor, a reciprocating screw and the moving member, a positioning cylinder is fixed to an end face of the motor having a rotating shaft, the positioning cylinder comprises a positioning channel, the positioning channel is arranged along a length direction of the positioning cylinder, the rotating shaft of the motor is located at a central position in the positioning channel, the reciprocating screw is located in the positioning channel and connects a driving end of the reciprocating screw rod with the rotating shaft of the motor, an inner wall of the positioning channel is provided with a circular hole, an outer peripheral wall of the reciprocating screw rod is recessed inwards to form two spiral grooves, the two spiral grooves have opposite directions of rotation and cross each other so as to be arranged in communication with each other, an arc-shaped member is provided in the positioning channel, and the arc-shaped member is placed in the spiral grooves; and an arc-shaped inner concave surface of the arc-shaped member is in contact with inner walls of the spiral grooves arranged along a length direction of the reciprocating screw, a circular shaft is formed in the middle of an arc-shaped outer convex surface of the arc-shaped member, the circular shaft is inserted into the circular hole, and the moving member is mounted on a connecting end of the reciprocating screw.

3. The telescopic rotating negative pressure massager according to claim 2, wherein the telescopic rotating device further comprises a guide rod, the positioning cylinder further comprises a guide end, cross sections of the positioning channel and the reciprocating screw are both arranged in a circular shape, and a circumferential outer wall of the reciprocating screw is adhered to and in clearance fit with a circumferential inner wall of the positioning channel; the guide rod is arranged along the length direction of the positioning cylinder, and the guide rod is fixed to the moving member; and the guide end is provided with a guide through hole, and the guide rod runs through the guide through hole.

4. The telescopic rotating negative pressure massager according to claim 3, wherein the positioning cylinder comprises a first sleeve body, a second sleeve body and a guide plate, the positioning channel is formed at a central position of the second sleeve body, the first sleeve body is socketed onto the second sleeve body in order to be fixed to each other, an end face of the second sleeve body facing the moving member is provided with a mounting table, one side of the guide plate facing the motor and the mounting table are provided with a recess with a semi-circular cross section, and the recess is arranged to extend radially; after the guide plate is fixed to the end face of the second sleeve facing the moving member, the two recesses are symmetrically assembled with each other to form a circular hole; and a guide hole is provided on the guide plate.

5. The telescopic rotating negative pressure massager according to claim 1, wherein a connecting member is connected to the moving member, the connecting member comprises a connecting plate, and a first positioning body and a second positioning body arranged around the connecting plate, the first positioning body and the second positioning body are connected to the connecting plate, and the first positioning body and the second positioning body are arranged at intervals;
the third connecting portion comprises a connecting ring body, the connecting ring body is sleeved on the connecting member; an outer wall of the first positioning body and an inner wall of the connecting ring body are respectively provided with a snap and a snap-in groove; an outer wall of the second positioning body and the inner wall of the connecting ring body are respectively provided with a positioning groove and a positioning block; and the snap is snap-connected in the snap-in groove; and the positioning block is embedded into the positioning groove.

6. The telescopic rotating negative pressure massager according to claim 1, wherein the first connecting portion is a connecting sleeve, the first housing further comprises a first opening, the first opening is in communication with the first accommodating cavity, the connecting sleeve is threaded into the first opening, and an outer wall of the connecting sleeve is snap-connected with an inner wall of the first opening; and a mounting channel is provided on the connecting sleeve, the mounting channel is arranged in a penetrating manner along a length direction of the first housing, and the telescopic rotating device is mounted in the mounting channel.

7. The telescopic rotating negative pressure massager according to claim 6, wherein the second connecting portion is a second opening, the second opening is in communication with the second accommodating cavity, the connecting sleeve is further threaded into the second opening, and the outer wall of the connecting sleeve and an inner wall of the second opening are snap-connected to each other.
